(19) United States
(12) Patent Application Publication
(10) Pub. No.: US 2018/0234563 A1
(43) Pub. Date: Aug. 16, 2018

(54) IMAGE FORMING APPARATUS

(71) Applicant: Sharp Kabushiki Kaisha, Sakai City (JP)

(72) Inventors: Megumi IDO, Sakai City (JP); Yasuhiro INOUE, Sakai City (JP); Yosuke KASHU, Sakai City (JP); Masahiro KAWANO, Sakai City (JP); Toshiyuki KONISHI, Sakai City (JP)

(21) Appl. No.: 15/889,316

(22) Filed: Feb. 6, 2018

(30) Foreign Application Priority Data
Feb. 10, 2017 (JP) 2017-023216
Sep. 13, 2017 (JP) 2017-175824

(51) Int. Cl. H04N 1/00; H04N 1/32

(52) U.S. Cl. CPC H04N 1/00496; H04N 1/00307; H04N 1/00315; H04N 1/00411; H04N 2201/0063; H04N 1/32683; H04N 1/00559; H04N 2201/0094; H04N 2201/006; H04N 1/00493

(57) ABSTRACT

An image forming apparatus, includes: a short-range wireless communication unit that performs wireless communication with a mobile terminal that is in proximity; an operating portion that receives operational instructions from a user; and an operation panel having a communication area of the short-range wireless communication unit and an operation area of the operating portion on the same surface. The operation panel is constructed such that the communication area of the short-range wireless communication unit is arranged around a corner portion on the near side of the operation area where the operating portion of the operation panel is arranged, as viewed from the user side who operates the operation panel.

This Nonprovisional application claims priority under 35 U. S C. § 119(a) on Patent Application No. 2017-023216 filed in Japan on 10 Feb. 2017 and Patent Application No. 2017-175824 filed in Japan on 13 Sep. 2017, the entire contents of which are hereby incorporated by reference.

### BACKGROUND OF THE INVENTION

### (1) Field of the Invention

The present invention relates to an image forming apparatus provided with a short-range wireless communication function enabling communication with a mobile terminal by a short-range wireless communication.

### (2) Description of the Prior Art

Recently, instead of a conventional method of capturing image data stored in an external mobile terminal into an image forming apparatus byway of a memory card, there has been proposed an image forming apparatus that captures image data by means of simple wireless communication. In particular, the image forming apparatus adopts such a contrivance that NFC(Near Field Communication), which has a low signaling rate, is used as a trigger for transmission of image data while the actual image data is transmitted from a mobile terminal to the image forming apparatus by WiFi(registered trademark) communication that is previously established.

Upon use of this configuration, it is necessary that an NFC equipped mobile terminal is brought close to the image forming apparatus. In this configuration, a communication area is provided in an operation panel with an operating portion through which the operator gives instructions to the image forming apparatus, whereby it is possible for the operator to operate the image forming apparatus in one place and readily locate the communication area section.

However, the arrangement of the communication area on the operation panel causes a risk of giving erroneous input by touching the operating portion for giving instructions to the image forming apparatus by mistake when the mobile terminal is brought close to the communication area.

To deal with this, Patent Document 1 proposes an image forming apparatus in which, by detecting the presence of an approaching object to the short-range detector, input to the area of the touch panel in the vicinity of the short-range wireless detector is made invalid so as to prevent an erroneous input.

### PRIOR ART DOCUMENTS

### Patent Documents

### [Patent Document 1]

Japanese Patent Application Laid-Open No. 2016-115046

### SUMMARY OF THE INVENTION

### Problems to be Solved by the Invention

In the image forming apparatus disclosed in the above patent document 1, the touch area for the mobile terminal is arranged around the middle portion in the depth direction of the operation panel, in the rear of the group of a plurality of keys. With recent trend of increase in the size of mobile terminals, part of the mobile terminal comes over the key group when the mobile terminal is placed over the touch area. As a result, if these keys detect the mobile terminal before detection of the presence of the mobile terminal, the image forming apparatus may execute a process due to erroneous input.

### SUMMARY OF THE INVENTION

In view of the above-described problem, it is therefore an object of the present invention to provide an image forming apparatus that does not react other instructions and cause erroneous operation when a short-range wireless communication is performed.

### Means for Solving the Problem

In order to solve the above problem, an image forming apparatus of the present invention includes: a short-range wireless communication unit that performs wireless communication with a mobile terminal that is in proximity; an operating portion that receives operational instructions from a user; and an operation panel including a communication area of the short-range wireless communication unit and an operation area of the operating portion, wherein the operation panel is constructed such that the communication area of the short-range wireless communication unit is arranged around a corner portion on a near side of the operation area where the operating portion of the operation panel is arranged, as viewed from a user side who operates the operation panel.

### Advantage of the Invention

In the image forming apparatus provided with the short-range wireless communication function disclosed by this specification, the communication area for communicating with mobile terminals can be separated from the operation area with the operating portion/control key operated by the user, it is hence possible to suppress occurrence of erroneous operations when a mobile terminal is placed over the communication area.

### BRIEF DESCRIPTION OF THE DRAWINGS

FIG. 1 is a perspective view of an MFP according to the present invention;

FIG. 2 is a block diagram showing the electrical configuration of the MFP;

FIG. 3 is a plan view showing an operation panel in a first embodiment;

FIG. 4 is an exploded perspective view showing the operation panel in the first embodiment;

FIG. 5 is a perspective view showing a portion of the operation panel in the first embodiment;

FIG. 6 is a perspective view showing a portion of the operation panel in the first embodiment (a view when a mobile terminal is put over);

FIG. 7 is a plan view showing an operation panel in a second embodiment;

FIG. 8 is a perspective view showing a portion of the operation panel in the second embodiment;

FIG. 9 is a perspective view showing a portion of the operation panel in the second embodiment (a view when a mobile terminal is put over);

FIG. 10 is a perspective view showing a portion of an operation panel in a third embodiment;

FIG. 11 is a perspective view showing a portion of the operation panel in the third embodiment (a view when a mobile terminal is put over);

FIG. 12 is a sectional view showing a portion of the operation panel in the third embodiment (a view when a mobile terminal is put over);

FIG. 13 is a perspective view showing a portion of an operation panel in a fourth embodiment;

FIG. 14 is a perspective view showing a portion of the operation panel in the fourth embodiment (a view when a mobile terminal is put over);

FIG. 15 is a sectional view showing a portion of the operation panel in the fourth embodiment (a view when a mobile terminal is put over);

FIGS. 16 (a) to 16 (c) are sectional views showing portions of operation panels in a fifth embodiment (views when a mobile terminal is put over); and

FIG. 17 is a sectional view showing a portion of an operation panel in a sixth embodiment (a view when a mobile terminal is put over).

### DESCRIPTION OF THE PREFERRED EMBODIMENTS

Now, embodiments for carrying out the present invention will be described with reference to the drawings. For description convenience, the embodiments will be described by giving an example using the MFP (Multifunction Peripheral) as the image forming apparatus of the present invention. However, it goes without saying that the present invention can be applied to any image forming apparatus as long as it uses a short-range wireless communication port and an operation panel of a touch panel type.

### <Configuration Common to First to Sixth Embodiments>

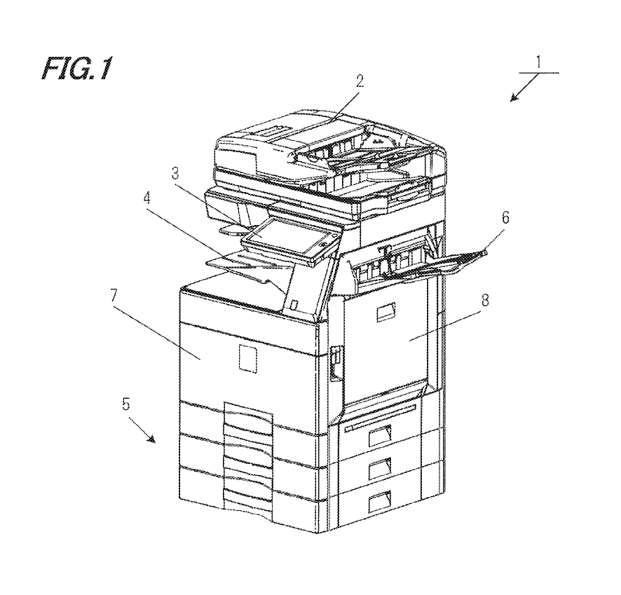

FIG. 1 shows an external view of an MFP (Multifunction Peripheral) 1 as an example according to the embodiment of the present invention.

The MFP 1 in FIG. 1 has various functions such as copy, facsimile, scan, server storage and the like, and includes an automatic document feeder 2, an operation panel 3, a paper discharge tray 4, a three-stage paper feed desk 5, a manual feed tray 6, a front cover 7 and a right side cover 8, as viewed externally.

The automatic document feeder 2 enables documents to read continuously by automatically feeding out the set documents. A scanner is arranged in the course of the document feed path so as to read the document passing through the station. When a pair of scanners may be arranged at the top and bottom so as to sandwich the document being conveyed between the scanners, it is possible to scan both sides of the document at the same time.

The operation panel 3 will be described in more detail later, but it functions as an interface that receives operational instructions from the user to give instructions to the MFP 1.

The paper discharge tray 4 is a tray to which the printed paper is discharged, and has a space for holding a plurality of sheets. Further, the printed sheets may be shifted to the left and right in job units by an unillustrated post-processor and output so as to be sort out.

The 3-stage paper feed desk 5 is a desk on which paper to be used for printing is set beforehand. In this example, each stage can hold a different type of paper so that three kinds of paper can be set.

The manual feed tray 6 enables paper feed of sheets other than the ones set on the above-described three-stage paper feed desk 5 to the MFP 1 by setting the sheets on this tray.

The front cover 7 can be opened by turning, and a power supply switch, toner cartridges, printing units and the like necessary for printing are housed therein.

The right side cover 8 is a cover that can be opened when performing a releasing operation in the case where a sheet has jammed in the middle of printing and conveyance.

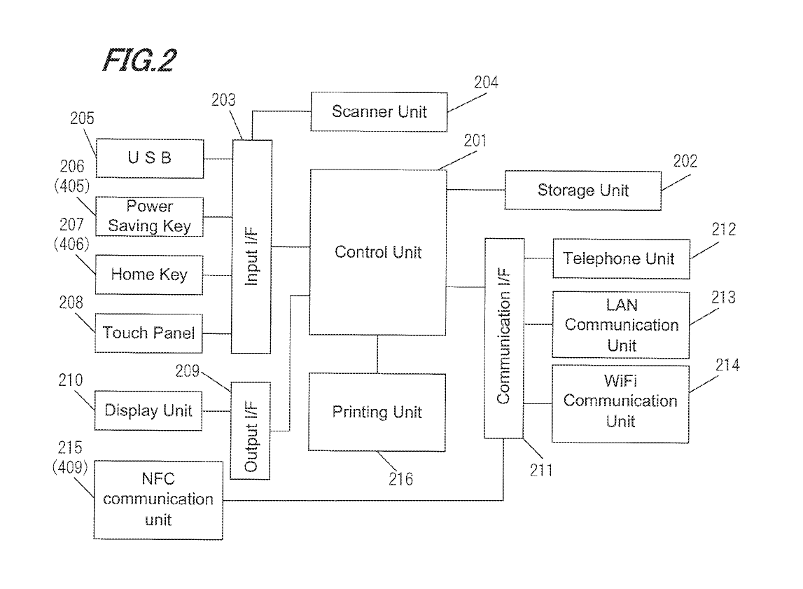

Next, FIG. 2 is a block diagram for explaining the functional configuration of the MFP 1. The control unit 201 is to control each unit of the entire MFP according to the content of a program stored in a storage unit 202 (to be described later), and includes a CPU (Central Processing Unit) for control, a high-speed memory as a work area and the like.

The storage unit 202 is composed of a HDD (Hard Disk Drive), a semiconductor storage unit such as an SSD (Solid State Drive), or the like, and has stored in advance a program for controlling the control unit 201. Other than this, various settings designated by the user are stored in a non-volatile manner.

The input I/F 203 receives signals from diverse input units such as a scanner unit 204, a USB (Universal Serial Bus) 205, a power saving key 206(405), a home key 207 (406) and a touch panel 208 to transfer the signals to the control unit 201.

The scanner unit 204 is used to read a document being conveyed through the automatic document feeder 2 of FIG. 1 or read a document set on a document platen (not shown), and is composed of an optical sensor such as a CCD (Charge Coupled Device) image sensor.

The USB 205 is an I/F connected to an external storage device (e.g., a USB memory etc.), and in the present embodiment, this enables reading from and writing to a USB memory.

The power saving key 206 (405) is to give instructions to shift the MFP 1 to the power saving mode in which power consumption is suppressed, and detects the operation from the user based on the change in the capacitance. In order to prevent mode transition due to an erroneous contact, the mode change is adapted to take place only when the input has continued for one second, for example.

The home key 207 (406) is to shift the operation screen to a screen for selection of various functions provided for the MFP 1. Similarly to the power saving key 206, the home key detects a user operation based on the change in the capacitance. However, since it is uneasy to use if a lapse of time is needed as the power saving key 206, the screen change is adapted to take place when the key is released after being operated.

The touch panel 208 is an analog resistance film type touch panel, which is provided on an aftermentioned display unit 210 and is used to detect an input to a position displayed on the display unit 210.

The touch panel 208 is not limited to the analog resistive film method that utilizes voltage division but may use a capacitive type using detection of a change in electrostatic capacitance between a finger and a pattern, an infrared light blocking method using detection based on blocking locations of irradiated infrared rays, or a camera system that specifies the position based on the shadow of the finger taken by the camera, in place of the analog resistive film method.

The output I/F 209 is to output an output signal from the control unit 201 to the user, and converts the output signal to information to be displayed on an unillustrated bit map based on the output from the control unit 201, and also generates the drive signal for driving the display unit 210 to supply the drive signal to the display unit 210.

The display unit 210 is to provide information to the user, and may use a flat display such as a liquid crystal display, an EL (electroluminescence) display, or the like.

A communication I/F 211 serves as a component for the MFP 1 to communicate with external devices, and is connected to a telephone unit 212 that performs FAX communication or the like using a telephone line, a LAN communication unit 213 that performs email communication via the Internet, a WiFi communication unit 214 capable of high-speed radio communication in a range of some tens of meters, and an NFC communication unit 215 (409) that performs wireless communication in a relatively short range.

The NFC communication unit 215 is a short-range wireless communication function unit that performs wireless communication with a terminal device (e.g., a mobile terminal) that is located in proximity thereto.

The printing unit 216 prints images by thermally pressing and fixing the toner to the paper fed from the 3-stage paper feed desk 5 or the manual feed tray 6 in FIG. 1.

### First Embodiment

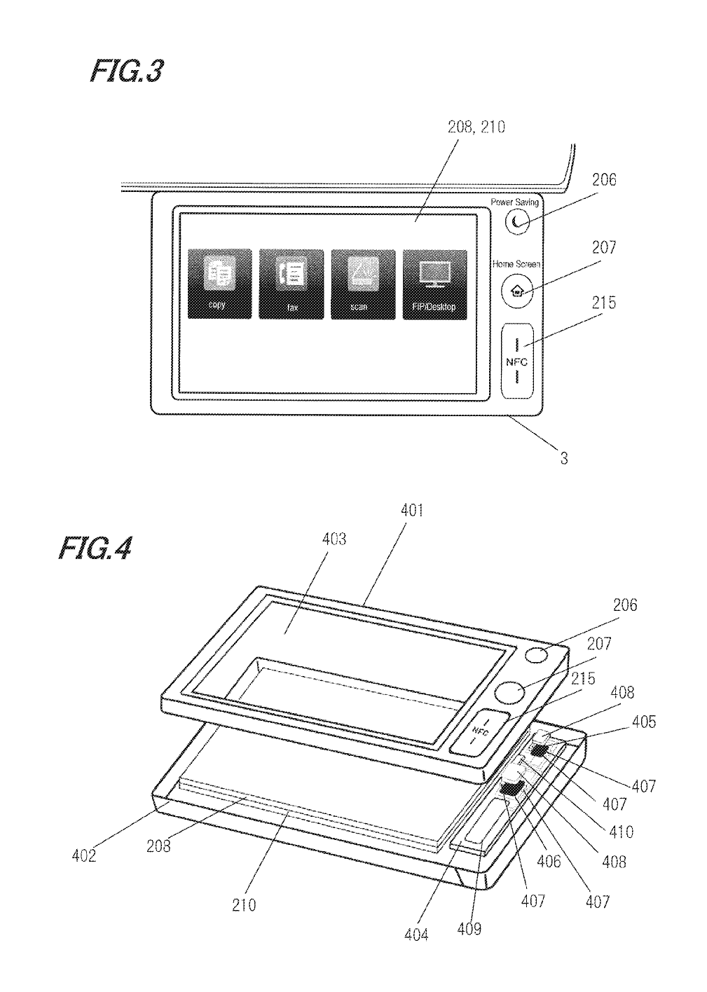

Next, a first embodiment will be described. FIG. 3 is a view showing the operation panel 3. In the drawing, the same reference numerals are given to the components related to FIGS. 1 and 2, and the explanation thereof will be omitted as necessary.

Provided in the central part of the operation panel 3 is a touch screen equipped with a touch panel 208 on the display unit 210. In the example of FIG. 3, four icons for selection of a copy function, a fax function, a scan function and a FTP/Desktop function are displayed on the display unit 210. When the user touches one of the displayed icons, the touch position is detected on the touch panel 208, so that the function corresponding to the icon displayed at the position corresponding to the touch position is executed.

Arranged on the right side of the touch screen are an area for detecting the power-saving key 206, an area for detecting the home key 207 and an area for performing communication via the NFC communication unit 215, in the order mentioned from the far side when the user uses the apparatus.

Here, the present embodiment is characterized by the fact that the communication area of the NFC communication unit 215, which is an NFC interface that performs communications using NFC, is arranged at the nearest position from the user side. That is, a communication area of the NFC communication unit 215 is arranged on an extended line in which the power saving key 206 and the home key 207 are arranged.

That is, as viewed from the side (the lower side in FIG. 3) the user operates the operation panel 3, the communication area of the NFC communication unit 215 is disposed on the near side of the operation area where operation components such as the power saving key 206 and the home key 207 are arranged. It is preferable that the communication area is arranged around the corner of the operation panel 3, but as long as it is arranged on the near side of the operation area, the communication area may be arranged other than the corner.

Further, the touch panel 208, the operation area (the power saving key 206 and the home key 207) and the communication area of the NFC communication unit 215 are provided on the same surface of the operation panel 3, which can provide a user-friendly operation panel.

FIG. 4 is an exploded perspective view of the operation panel 3. The operation panel 3 is formed of an upper cabinet 401 and a lower cabinet 402, and is fixed to the MFP 1 rotatably about an unillustrated rotational shaft on the underside of the lower cabinet 402.

The upper cabinet 401 is formed with a hollow window portion 403 so as to offer a view field of the display portion 210 within the operation panel 3 and enable the touch panel 208 to be touch-operated through the window portion 403.

In addition, a substrate 404 is arranged beside the display portion 210 and the touch panel 208. On the substrate 404, a first electrostatic detector 405 serving as the power saving key 206 and a second electrostatic detector 406 serving as the home key 207 are provided so as to detect a user's operation based on the change in capacitance.

LED devices 407 for illumination are provided at both ends of each pattern of the first and second electrostatic detectors 405 and 406. Also, in order to guide light upward from the LED elements 407, a light guide plate 408 is arranged over each pattern of the first and second electrostatic detectors 405 and 406 in a manner not so much as affecting the detection of capacitance.

The light guided by the light guide plate 408 can been seen through the upper cabinet 401 by making the corresponding area of the upper cabinet 401 translucent, whereby it is possible to easily confirm the positions of the keys.

Though in the present embodiment, capacitive switches that detect operational inputs based on capacitance detection are used for the power saving key 206 and the home key 207, it is of course possible to employ a simple pressure detection switch or a switch of a mechanical structure. Further, these switches may be used in combination, that is, for example, the home key 207 may use a capacitance type switch while the power saving key 206 may use a switch of a mechanical structure.

In addition, though the power saving key 206 and the home key 207 have been described as examples of the switches provided in the operation area, either only a single switch or additional switches may be provided. For example, switches that can perform other operations such as clear key, mode change key, login key, power key may be provided additionally or instead.

The substrate 404 further includes a loop antenna 409 as a wiring pattern to enable NFC communication, which is short-range wireless communication. The loop antenna 409 is a communication input/output unit with a terminal device such as a smartphone capable of NFC communication, for example.

Each part provided on the substrate 404 is connected to the input I/F 203 and the communication I/F 211 via a connector 410, and controlled by the control unit 201.

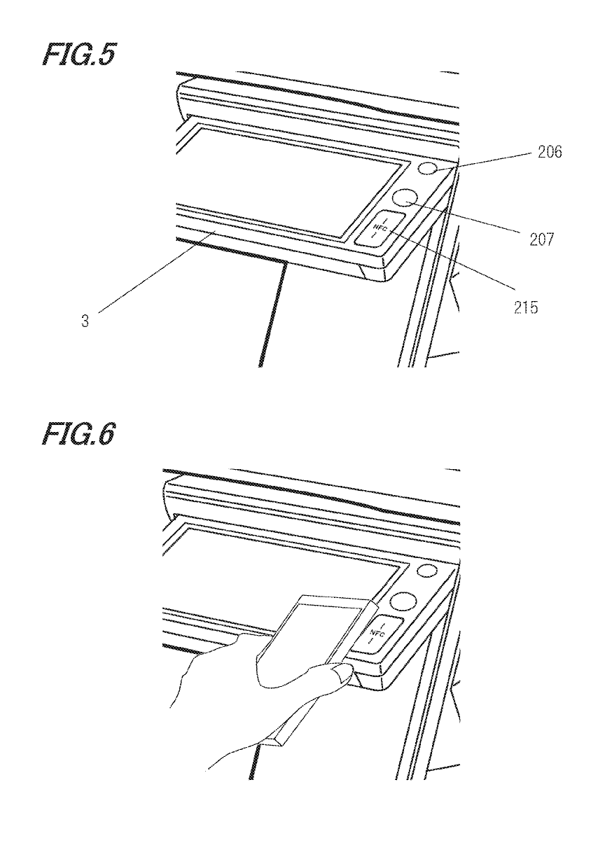

FIG. 5 is a perspective view of the operation panel 3. When the user executes communication between the MFP 1 and a mobile terminal, the mobile terminal is brought close to the area (communication area) provided with the NFC communication unit 215 as shown in FIG. 6 to perform communication.

At this time, since the area where the NFC communication unit 215 is provided is located on the nearest side, it is possible to place the mobile terminal over the NFC communication unit so as not to overlap the power saving key 206 and the home key 207, compared to the case where the NFC communication unit 215 is provided on the far side or in the middle.

In addition, since the home key 207 is configured to start its operation at the releasing time instead of the input timing, even if the mobile terminal overlaps the home key when the mobile terminal is held over the NFC communication unit 215 and an erroneous detection is made by the home key 207, it is possible to prevent malfunction as long as communication between the NFC communication unit 215 and the mobile terminal starts before the mobile terminal is removed from the home key 207 so that the input to the home key 207 is invalidated.

That is, when the NFC communication unit 215 detects the start of NFC communication, the input to the home key 207 may be invalid. In addition, the input to the power saving key 206 may also be invalidated.

### Second Embodiment

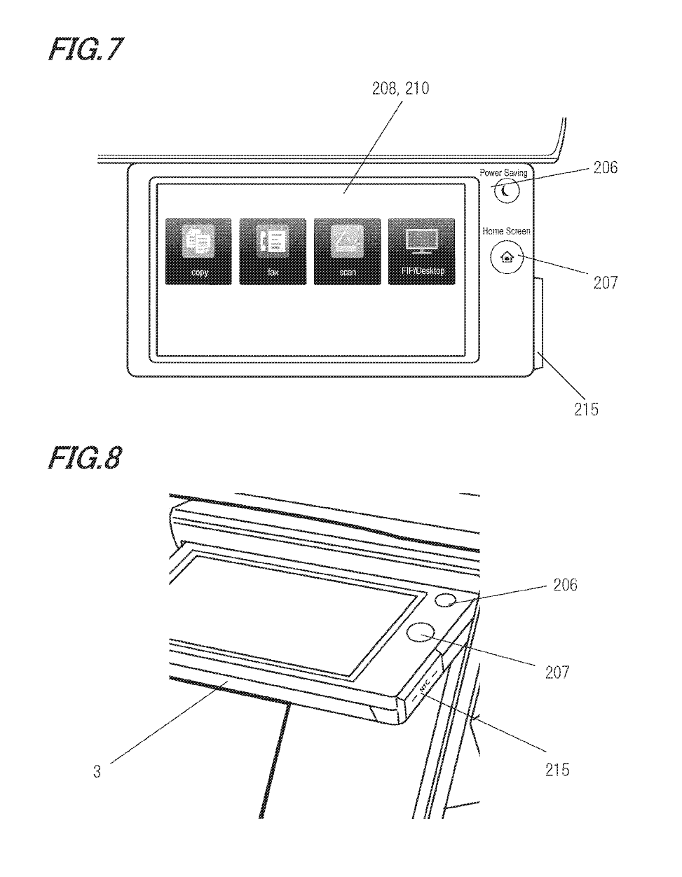

Next, the second embodiment will be described with reference to FIGS. 7, 8 and 9.

As compared with the first embodiment, the second embodiment is characterized in that the communication area of the NFC communication unit 215 is not arranged on the surface of the operation panel 3 where the power saving key 206 and the home key 207 are arranged, but is arranged on the side face where no keys are provided hence NFC communication unit is less likely to interfere with the keys.

FIG. 8 is a perspective view of the operation panel 3 according to the second embodiment. In the example of the present embodiment, the area of the NFC communication unit 215 is arranged on the side face of the operation panel 3. That is, the communication area of the NFC communication unit 215 is arranged in a position orthogonal to the area where the power saving key 206 and the home key 207 are provided. The position of this side face is arranged on the right side (the side where the home key 207 is provided) in FIG. 8, but it may be arranged on the opposite side which is the left side or on the underside.

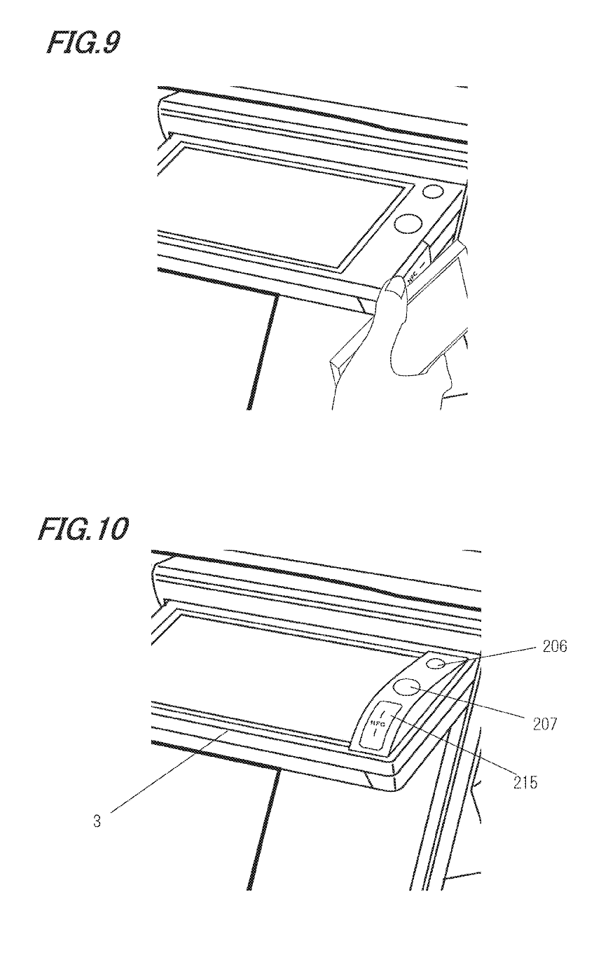

Arranging the area of the NFC communication unit 215 on the side face of the operation panel 3 enables the mobile terminal to be placed thereover from the side as shown in FIG. 9, hence it is possible to avoid interference with other keys.

In order to arrange the area of the NFC communication unit 215 on the side face of the operation panel, the part of the loop antenna 409 on the single substrate 404 in FIG. 4 of the first embodiment should be separately formed and arranged.

In the NFC communication with mobile terminals, except when communication is completed in a short time such as for authentication, NFC communication is used as a trigger for starting communication when bulky files such as photographs are exchanged with mobile terminals and the actual file is transmitted via WiFi communication. Accordingly, since the time for holding the mobile terminal is short and no operation is needed on the mobile terminal side, there occurs no problem even if the area is provided on the side of the operation panel.

Since the area of the NFC communication unit 215 is not provided on the surface of the operation panel 3, the user may be able to locate the NFC communication unit 215. Therefore, in order to easily find the area where the NFC communication unit 215 is provided, the area is preferably configured to have a structure that enables the user to easily confirm the position by projecting the part as shown in FIGS. 7 to 9.

Further, in order to make the NFC communication unit 215 easily visible to the user, a light emitter such as an LED may be provided so as to indicate the position of the NFC communication unit 215.

### Third Embodiment

Subsequently, the third embodiment will be described with reference to FIGS. 10, 11, and 12. In this embodiment, inclined portions are formed on the operation panel so that the operation area and the communication area can be provided on different portions with different inclination angles.

This embodiment is the same as the first embodiment in that the area of the NFC communication unit 215 is formed on the surface of the operation panel 3 but is different in that a slope is formed in that area.

An example in this embodiment is characterized in that part of the operation panel 3 is gradually raised from the near side to the far side (the vicinity of the middle part), so that the communication area of the NFC communication unit 215 is provided on the near side of the vertex of the inclination while the operation area of the other components, i.e., the power saving key 206 and the home key 207 is arranged in a gradually low inclined area from the vertex (the vicinity of the middle part) of the slope toward the far side.

That is, the communication area of the NFC communication unit 215 is provided on the slope that is raised from the near side of the operation panel 3 toward the far side, and the operation area is arranged on another slope with a different inclination angle of the operation panel 3.

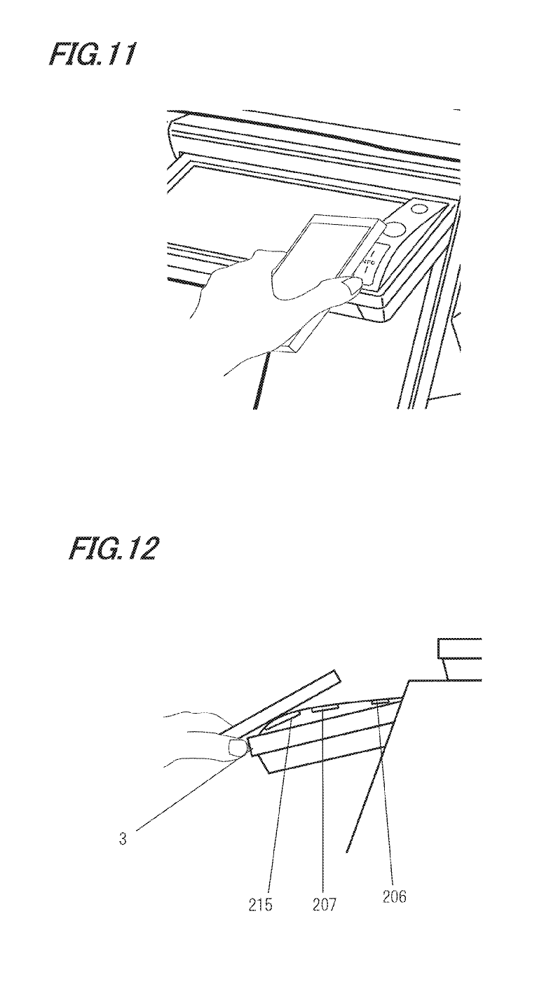

As a result, even if the mobile terminal is placed at a position overlapping the area of the home key 207, which would cause erroneously detection due to the change in electrostatic capacitance, the arrangement of the detection area in above way makes it possible to keep the mobile terminal distant from the keys as shown in FIG. 12, hence prevent erroneous detection.

Though in the above-described embodiment, the slopes are formed from the near side to the far side of the operation panel 3, the slopes may be arranged along the left-right direction. Specifically, a first slope is formed so as to gradually rise from the right side of the operation panel 3 toward the vicinity of the center as viewed from the user, whereas a second slope is formed so as to gradually lower from the vicinity of the center toward the left side. Then, the communication area may be provided in the first slope and the operation area may be provided in the second slope.

Further, the above-described communication area and operation area may be reversed. For example, the operation area may be provided on the front side and the communication area may be provided on the interior side. In this case, since the inclination is formed by different slopes, even if the mobile terminal is put over the NFC communication unit 215, the mobile terminal will touch the power saving key 206 and the home key 207 at a different angle so that erroneous detection can be avoided.

### Fourth Embodiment

Next, the fourth embodiment will be described with reference to FIGS. 13, 14 and 15.

As an example, the present embodiment is characterized in that a curved surface having a smooth radius is formed from the top to the side of the operation panel 3 while the operation area including the power saving key 206 and the home key 207 is arranged at a position different from the area of the NFC communication unit 215 on the curved surface.

Regarding the installation of the loop antenna 409 in the rounded portion, it is possible to form a loop antenna on, for example, an FPC (Flexible Printed Circuits) and arrange it along the rounded portion. Alternatively, it is possible to simply fix a hard substrate obliquely because connection is performed via radio waves.

The arrangement of each detection area in the above manner can assure the necessary distance for the power saving key 206 and the home key 207 to avoid erroneous detection when the mobile terminal is put over the NFC communication unit 215 as shown in the sectional view of the operation panel 3 in FIG. 15.

In FIG. 13, FIG. 14 and FIG. 15, the rounded portion is formed on the right side of the operation panel 3 so that the communication area is provided around the corner on the near side. However, the rounded portion may be formed in a different position. For example, the rounded portion may be formed on the underside or, on the other side, i.e., the left side, so as to arrange the communication area. Further, though it is preferable that the operation area and the communication area are positioned aslant/separately (for example, the operation area is on the interior side and the communication area is on the near side), as shown in FIG. 13. However, these areas may be arranged side by side.

In particular, when there are many control keys in the operation area, the keys may be laid out on the entire operation panel 3. In such a case, the operation area and the communication area may be formed side by side.

### Fifth Embodiment

Next, the fifth embodiment will be described with reference to FIGS. 16(a) to 16(c).

As an example of the present embodiment, a projected portion 240 is provided between the operation area of the operation panel 3 and the area of the NFC communication unit 215. FIG. 16(a) is a sectional view of the operation panel 3. Here, a projected portion 240a is arranged, so that even if the mobile terminal is placed over the NFC communication unit 215, erroneous detection can be prevented by creating a distance from the power saving key 206 and the home key 207.

Herein, the projected portion 240 is preferably as high as to allow the mobile terminal to communicate with the NFC communication unit 215 even if the mobile terminal touches the projected portion 240. Further, the projected portion 240 may take various shapes. For example, it may have a pointed peak as given by a projected portion 240b in FIG. 16(b), or it may have a flat top as given by a projected portion 240c of FIG. 16(c). That is, the projected portion may have any shape as long as it can prevent the mobile terminal from touching the power saving key 206 and the home key 207 even when the mobile terminal is put over the NFC communication unit 215.

### Sixth Embodiment

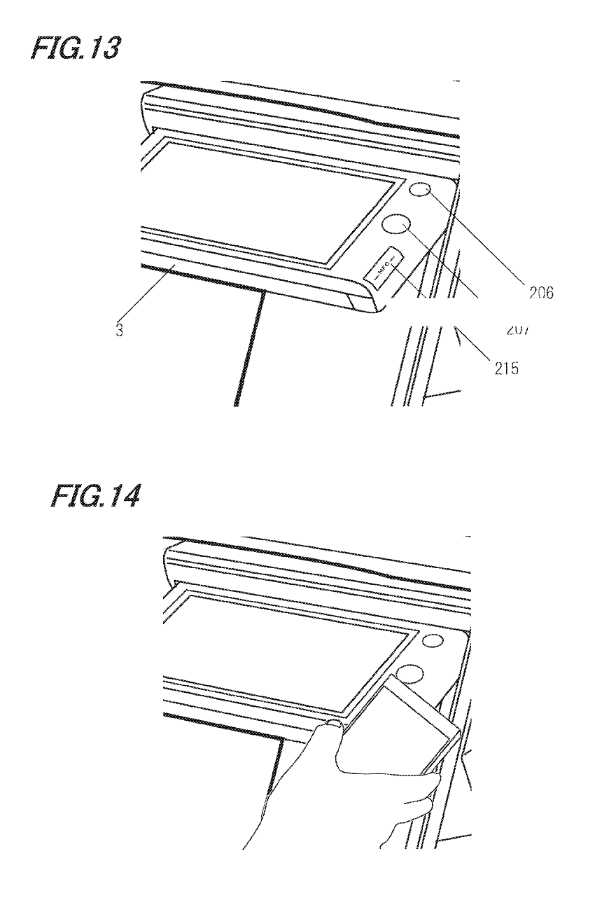

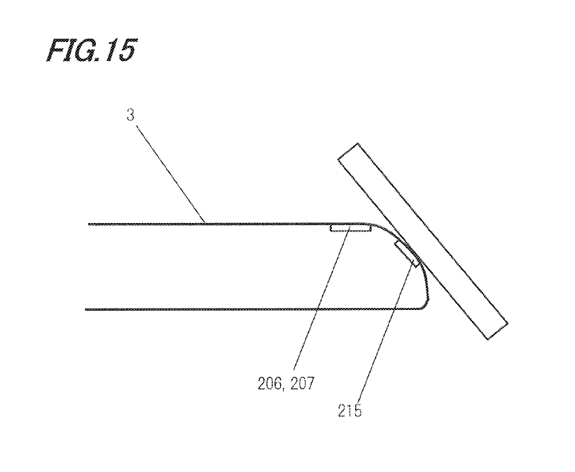

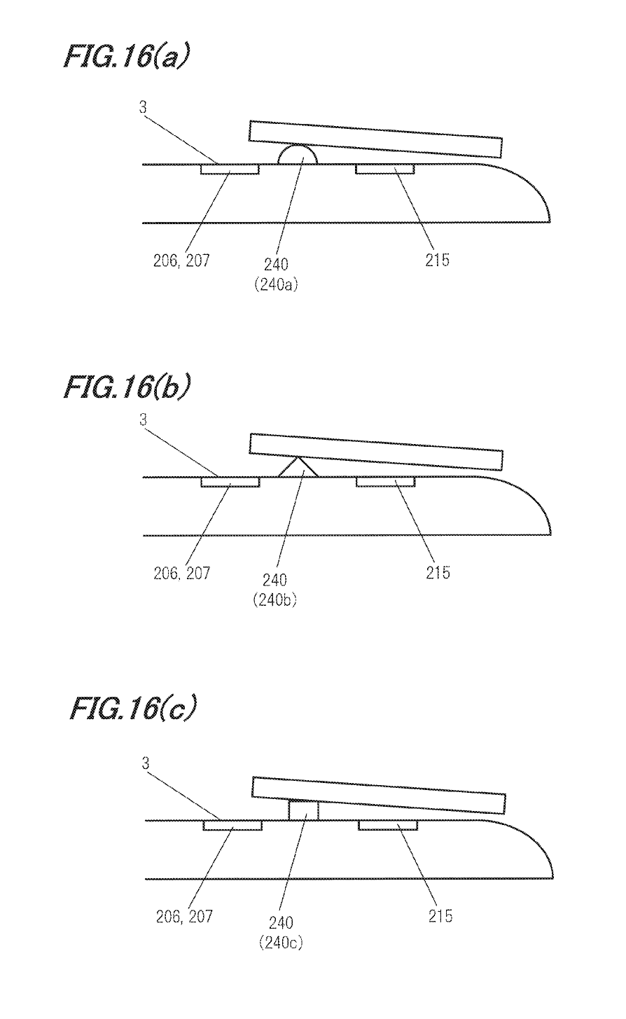

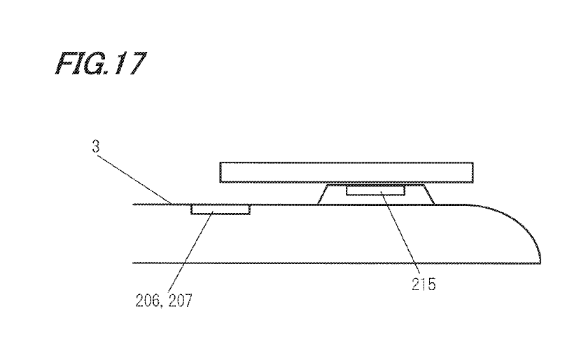

Next, the sixth embodiment will be described with reference to FIG. 17.

As an example of this embodiment, the operation area of the operation panel 3 and the area of the NFC communication unit 215 are made to have different heights. FIG. 17 is a sectional view of the operation panel 3. That is, in the operation panel 3, the NFC communication unit 215 is provided at a place (on a table) higher than the power saving key 206 and the home key 207. Therefore, when the mobile terminal is put over the NFC communication unit 215, the mobile terminal can communicate without touching the power saving key 206 and the home key 207.

### Variational Examples

Although the embodiment of the present invention has been described in detail with reference to the drawings, the specific configuration is not limited to the above embodiments, and designs and the like without departing from the gist of the present invention should also be included in the scope of the invention.

Though the above-described embodiments have been described by using the MFP as an example of the image forming apparatus, it is obvious that the present invention may be applied to an apparatus such as a simple facsimile machine, a printer, a photo printer or the like.

Further, the above embodiments were given by describing cases where communication with the mobile terminal device is performed by NFC communication, but other short-range wireless communication may be used. For example, the present invention can be applied in the same manner to perform communication for authentication cards using RFID.

### DESCRIPTION OF REFERENCE NUMERALS

1 MFP
3 operation panel
4 paper discharge tray
5 three-stage paper feed desk
6 manual feed tray
7 front cover
8 right side cover
201 control unit
202 storage unit
204 scanner unit
206 power saving key
207 home key
208 touch panel
210 display unit
212 telephone unit
213 LAN communication unit
214 WiFi communication unit
215 NFC communication unit
216 printing unit

What is claimed is:

1. An image forming apparatus, comprising:
a short-range wireless communication unit that performs wireless communication with a mobile terminal that is in proximity;
an operating portion that receives operational instructions from a user; and
an operation panel including a communication area of the short-range wireless communication unit and an operation area of the operating portion,
wherein
the operation panel is constructed such that the communication area of the short-range wireless communication unit is arranged around a corner portion on a near side of the operation area where the operating portion of the operation panel is arranged, as viewed from a user side who operates the operation panel.

2. The image forming apparatus according to claim 1, wherein at least one key of electrostatic capacitance detection is provided in the operation area of the operating portion in the operation panel.

3. The image forming apparatus according to claim 1, wherein a plurality of keys are provided in the operation area of the operating portion of the operation panel, and the communication area is provided on an extension line of the plurality of keys.

4. The image forming apparatus according to claim 1, wherein
the communication area is provided on an inclined portion that is inclined upward from the near side to an interior side of the operation panel; and
the operation area is arranged on an inclined portion with a different inclination angle other than that of the inclined portion on the operation panel.

5. The image forming apparatus according to claim 4, wherein the operation area is provided on the inclined portion that is located on the interior side of the communication area on the operation panel and inclined downward toward the interior side.

6. The image forming apparatus according to claim 1, wherein the operation panel has an inclined portion formed from a top surface to a side surface on the operation panel, the operation area is arranged on the top surface and the communication area is arranged on the inclined portion.

7. The image forming apparatus according to claim 1, wherein a projected portion is formed between the operating portion and the communication area of the short-range wireless communication unit.

8. The image forming apparatus according to claim 1, wherein the communication area of the short-range wireless communication unit is provided in a region having a height different from that of the operating portion.

9. The image forming apparatus according to claim 1, wherein the communication area of the short-range wireless communication unit and the operation area of the operating portion are arranged on the same surface.

10. The image forming apparatus according to claim 1, wherein the communication area of the short-range wireless communication unit and the operation area of the operating portion are arranged on different surfaces.

11. The image forming apparatus according to claim 10, wherein the communication area is arranged on a surface perpendicular to the operation area of the operation panel.
